(19) United States
(12) Patent Application Publication
(10) Pub. No.: US 2007/0074065 A1
(43) Pub. Date: Mar. 29, 2007

(54) COMPUTER, METHOD OF CONTROLLING MEMORY DUMP, MECHANISM OF CONTROLLING DUMP, AND MEMORY DUMP PROGRAM

(75) Inventor: Kumiko Suzuki, Tokyo (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC Corporation, Minato-ku (JP)

(21) Appl. No.: 11/535,102

(22) Filed: Sep. 26, 2006

(30) Foreign Application Priority Data
Sep. 26, 2005 (JP) 2005-277591

(51) Int. Cl. G06F 11/00

(52) U.S. Cl. 714/5

(57) ABSTRACT

An apparatus of an exemplary embodiment of the present invention includes first and second memories and a storage unit. Further, an indication which indicates necessity of a memory dump is provided with the apparatus. A first unit boots the apparatus without using the second memory when the indication indicates the necessity of the memory dump. The apparatus has a second unit which copies the content of the second memory into the storage unit and a third unit which copies the content of the first memory into the second memory, wherein the content of the first memory is formed when the first unit boots the apparatus.

### BACKGROUND OF THE INVENTION

The present invention relates to a computer, a method of controlling a memory dump, a mechanism of controlling a dump, and a memory dump program, and particularly relates to a computer, a method of controlling a memory dump, a mechanism of controlling dump, and a memory dump program, which duplex a memory once again without rebooting a system after completion of a dump.

Conventionally, in a case where a system crash has occurred in a computer system, it is necessary to produce a memory dump for the purpose of examining a cause of the system crash. In recent years, there has been a computer system in which a bulk memory can be mounted. Memories are expected to be become increasingly larger in capacity in the future. A computer system having a bulk memory also requires a memory dump. Time required for generating a memory dump results in downtime of the computer system. An increase in downtime cannot be ignored in the computer system having a bulk memory.

In a case where a system crash has occurred in a computer system, memory dump processing is caused. While memory dump processing is being performed, downtime is caused. This is because it is impossible to shut down and reboot the computer system. Memory dump time increases in proportion to a capacity of a mounted memory. In a computer system having a large-capacity memory mounted thereon, an enormous amount of time is required for a memory dump time, thereby an increase in downtime is brought about. Memory dump time ranges from several minutes to several ten minutes depending on a system configuration.

In Japanese Patent Application Publication No. 2004-102395, an apparatus for solving this problem is disclosed. This apparatus includes duplexed main storage memories, and data of the same contents are constantly retained in both of the memories. At the time of failure occurrence, the apparatus performs a reboot process by loading data necessary for rebooting a computer system into one (a master memory) of the memories. The other one (a slave memory) of the memories retains data as memory dump data at the time of the failure occurrence. However, after the completion of a dump, duplexing a memory requires another rebooting of the system. This is because the system operates only with the master memory while the dump data is being retained in the slave memory.

### SUMMARY OF THE INVENTION

An object of the present invention is to provide a computer, a method of controlling a memory dump, a mechanism of controlling a dump, and a memory dump program, which duplex a memory once again without rebooting a system after the completion of a dump.

According to one aspect of the present invention, an apparatus, is provided which includes: first and second memories; an indication which indicates necessity of a memory dump; a storage unit; a first unit which boots the apparatus without using the second memory when the indication indicates the necessity of the memory dump; a second unit which copies the content of the second memory into the storage unit; and a third unit which copies the content of the first memory into the second memory, wherein the content of the first memory is formed when the first unit boots the apparatus.

According to another aspect of the present invention, an apparatus, is provided which includes: first and second memories; first and second memories; a first indication which indicates the first and second memories does not store the same contents; a storage unit; a first unit which boots the apparatus without using the second memory and activates the first indication; a second unit which copies the content of the second memory into the storage unit in accordance with the first indication; and a third unit which copies the content of the first memory into the second memory in accordance with the first indication, wherein the content of the first memory is formed when the first unit boots the apparatus.

According to one aspect of the present invention, a method for dumping a memory in an apparatus which includes first and second memories, a storage unit and an indication which indicates necessity of a memory dump, is provided which includes: booting the apparatus without using the second memory when the indication indicates the necessity of the memory dump; copying the content of the second memory into the storage unit; and copying the content of the first memory into the second memory, wherein the content of the first memory is formed by the booting step.

According to another aspect of the present invention, a method for dumping a memory in an apparatus which includes first and second memories, a storage unit, and a first indication which indicates the first and second memories does not store the same contents, is provided which includes: booting the apparatus without using the second memory based on the second indication; activating the first indication; copying the content of the second memory into the storage unit in accordance with the first indication; and copying the content of the first memory into the second memory in accordance with the first indication, wherein the content of the first memory is formed by the booting step.

### BRIEF DESCRIPTION OF THE DRAWINGS

Other features and advantages of the invention will be made more apparent by the following detailed description and the accompanying drawings, wherein:

FIG. 1 is a block diagram of a apparatus of an exemplary embodiment of the present invention;

FIG. 2 is a block diagram of a dump controller;

FIG. 3 is a sequence chart showing operations performed in a case where a system crash has occurred;

FIG. 4 is a sequence chart showing operations for performing a memory dump at the time of booting; and

FIG. 5 is a sequence chart showing operations performed in a case where a computer system is shut down without a system crash.

In the drawings, the same reference numerals represent the same structural elements.

### DETAILED DESCRIPTION OF THE PREFERRED EMBODIMENT

A first embodiment of the present invention will be described in detail below.

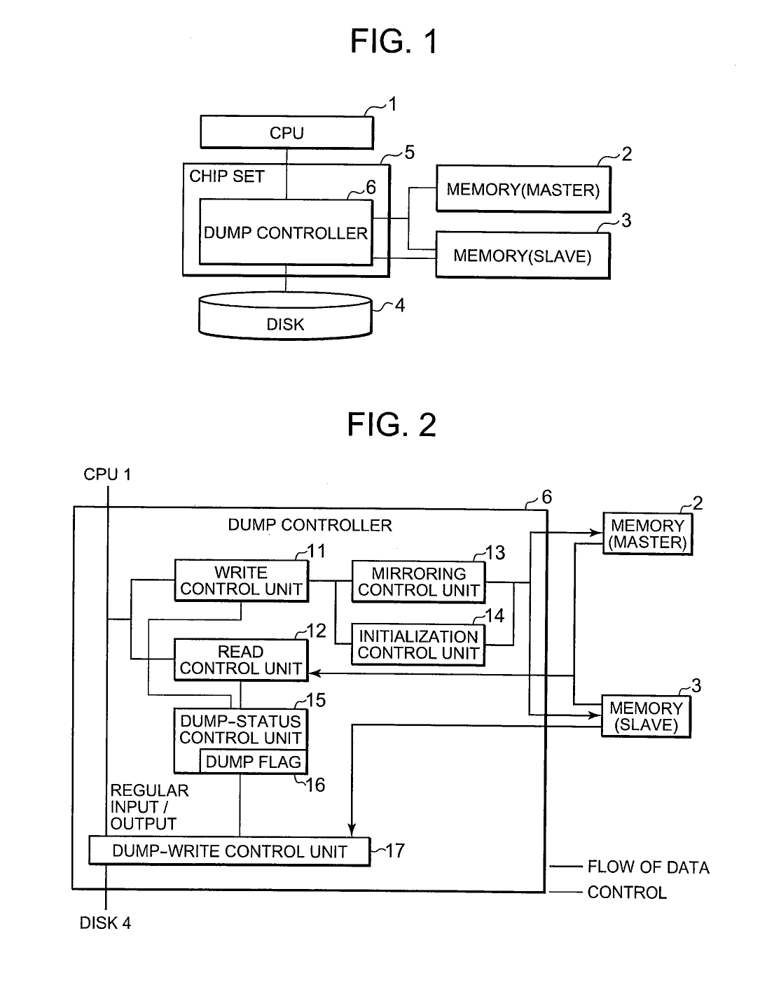

Referring to FIG. 1, a computer of the present invention includes a CPU 1, a master memory 2, a slave memory 3, a storage unit 4, and a chip set 5. The storage unit 4, in this embodiment, is a disk. The chip set 5 includes a dump controller 6. This computer has a memory mirror configuration. The dump controller 6 has interfaces 61 and 62. The interface 61 writes data to, and reads the data from, the master memory 2 and slave memory 3. The interface 62 only reads the data from the slave memory 3.

Referring to FIG. 2, the dump controller 6 includes a write control unit 11, a read control unit 12, a mirroring control unit 13, an initialization control unit 14, and a dump-status control unit 15, a dump flag storage unit 16, and a dump write control unit 17. The dump-status control unit 15 controls, responding to a dump-processing request from an operating system (OS), a transmission of a dump completion signal. In a case where write processing is requested onto the memories 2 and 3, the write control unit 11 controls, by referring to the dump-status control unit 15, which one of the master memory 2 and the slave memory 3 should be used for the write processing. In a case where read processing is requested on the memories 2 and 3, the read control unit 12 controls which one of the master memory 2 and the slave memory 3 should be used for the read processing. The mirroring control unit 13 performs mirroring of the master memory 2 and slave memory 3. That is, the mirroring control unit 13 controls the simultaneous writing into the master memory 2 and the slave memory 3. The initialization control unit 14 performs initialization of the master memory 2 and the slave memory 3. The dump flag storage unit 16 stores a dump flag 1600. In, a case where the dump flag 1600 is “1,” i.e., indicates that a memory dump is necessary, the dump write control unit 17 reads dump data from the slave memory 3, and writes the data into the disk 4. The dump write control unit 17 exclusively controls disk-write processing from the CPU 1 as regular input and output, and dump-write processing.

In a case where a system crash has occurred in a computer system having the memory mirror configuration, the dump controller 6 does not perform dump processing at the time of the occurrence of the system crash, but immediately shuts down and reboots the computer system. At the time of the rebooting, the dump controller 6 initializes only the master memory 2, and reboots an OS only with the master memory 2. The dump controller 6 causes the slave memory 3 to retain contents thereof, and writes the dump data retained in the slave memory 3 into the disk 4, in parallel with initialization of the master memory 2, and also in parallel with operation of the OS. Thereafter, the dump controller 6 performs duplexing by copying the contents of the master memory 2 to the slave memory 3. In this manner, the dump controller 6 immediately shuts down and reboots the computer system in a case where a system crash has occurred. Additionally, the dump controller 6 causes the OS to operate at an early stage by the rebooting, and generates a memory dump. The dump controller 6 duplicates the memories without rebooting the system thereafter.

Next, the operations of the embodiment will be described.

First, an operation in a case where a system crash has occurred will be described.

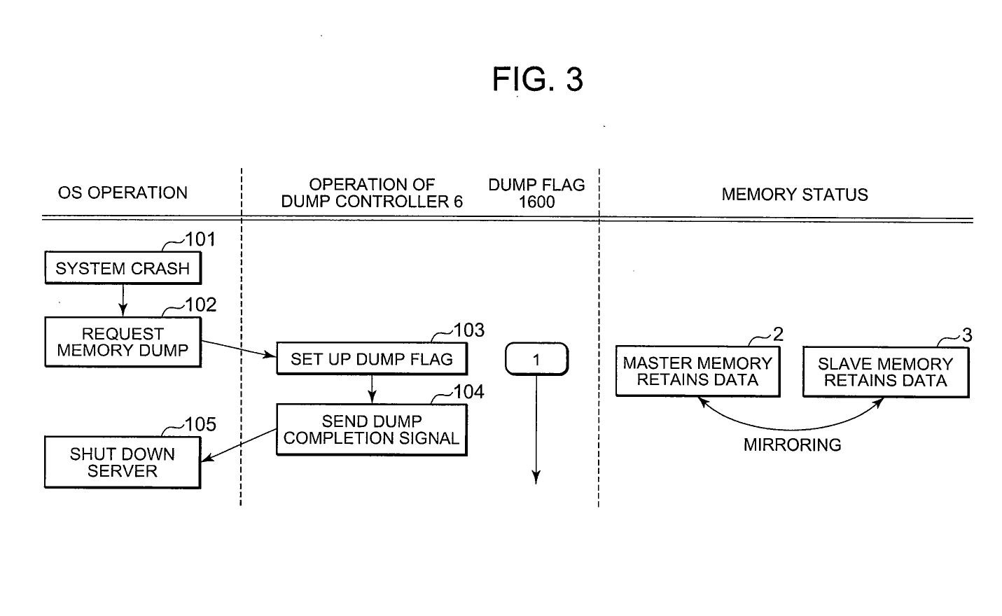

Referring to FIG. 3, in a case where a system crash has occurred (step 101), memory read processing is caused by a memory dump request (step 102) from the OS. The dump-status control unit 15 causes the dump flag 1600 in the dump flag storage unit 16 to take up “1” (step 103). The read control unit 12 returns a dump completion signal to the OS (step 104). The returning of the dump completion signal indicates the completion of the dump, thereby the computer system is shut down (step 105). At this point of time, the master memory 2 and the slave memory 3 maintain the mirror configuration, and are left retaining dump data.

Second, an operation of performing a memory dump at the time of booting will be described. As has been described above, because the computer system has been shut down due to a system crash, this processing is performed on the premise that the dump flag 1600 takes up “1.”

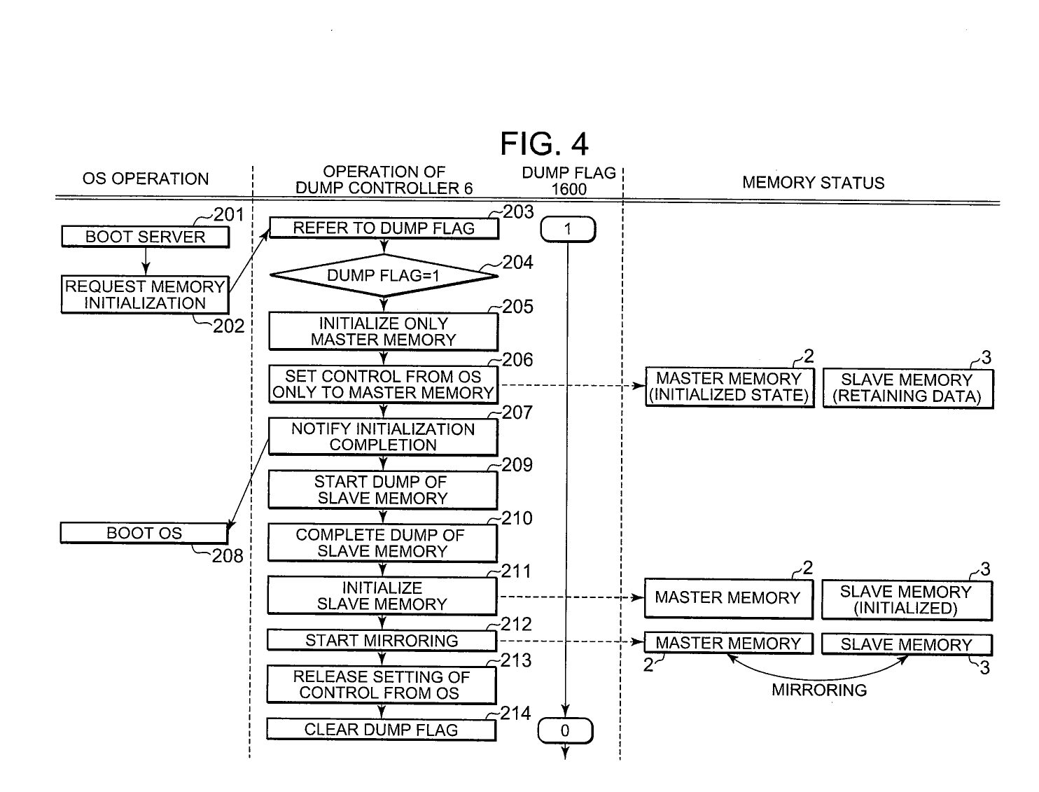

Referring to FIG. 4, when the computer system has been booted (step 201), a request is made by memory initialization processing to write zero into the memory 2 (step 202). By referring to the dump flag 1600 of the dump-status control unit 15, the write control unit 11 confirms that there is a need for a dump (steps 203 and 204). The write control unit 11 controls the initialization control unit 14 so that only the master memory 2 is initialized (step 205). While the dump flag 1600 takes up “1,” control is made so that the read control unit 12 and the write control unit 11 access only the master memory 2 (step 206). After the completion of the initialization of the master memory 2, the dump controller 6 returns a status of the initialization completion (step 207), thereby the OS is booted (step 208).

On the other hand, processing (write processing from the slave memory 3 to the disk 4) of the memory dump is performed on the slave memory 3. Processing of reading the dump data from the slave memory 3, and writing the data into the disk 4 is performed by the dump write control unit 17 (step 209). When the writing is completed (step 210), the dump-status control unit 15 instructs the write control unit 11 to initialize the slave memory 3 (step 211). The initialization is performed by the initialization control unit 14. Additionally, when the initialization is completed, the mirroring control unit 13 causes the master memory 2 and the slave memory 3 to have a mirror configuration (step 212). The dump-status control unit 15 clears the dump flag 1600, thereby indicating that there is no need for a dump (step 214). In this embodiment, the dump-status control unit 15 causes the dump flag 1600 to take up “0.”

Next, an operation performed in a case where the computer system is properly shut down without a system crash having been occurred will be described.

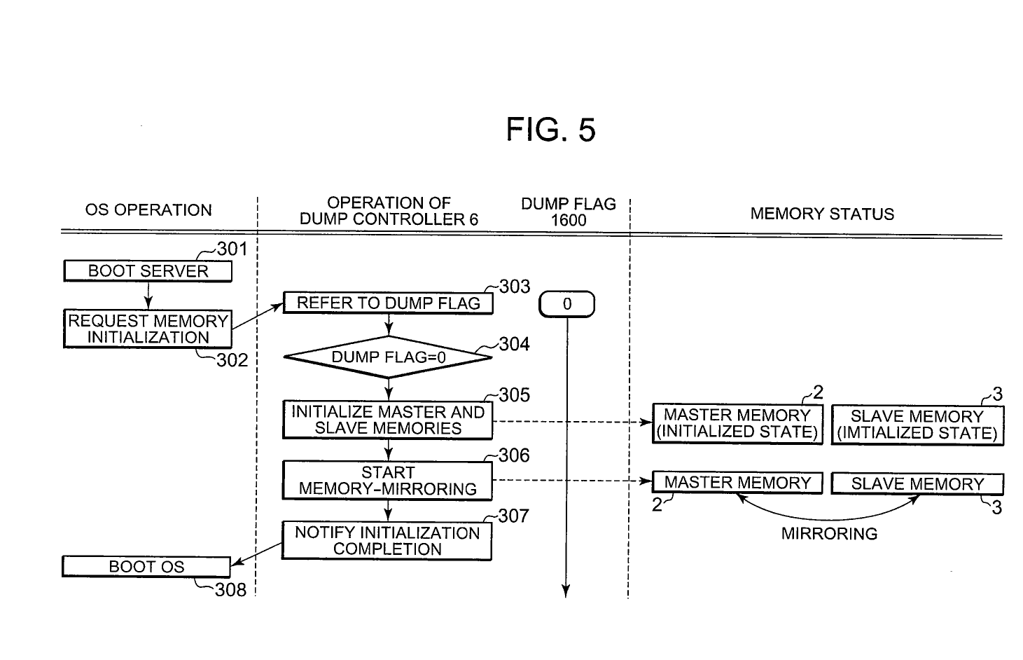

Referring to FIG. 5, in a case where there is a memory initialization request at the time when the computer system is booted (steps 301 and 302), the dump-status control unit 15 confirms, by referring to the dump flag 1600, that the dump flag 1600 takes up “0” (steps 303 and 304). When it is confirmed that the dump flag 1600 indicates that there is no need for a dump, the initialization control unit 14 initializes both the master memory 2 and the slave memory 3 (step 305), and the mirroring control unit 13 performs mirroring on the master memory 2 and slave memory 3 (step 306). The dump controller 6 returns initialization completion to the OS (step 307), thereby the OS is booted (step 308). Since the dump flag 1600 takes up “0,” write processing is performed onto both of the master and slave memories 2 and 3, respectively.

Note that the functions of the dump controller 6 may be performed by having a program, which realizes the functions thereof, recorded in a computer-readable recording medium, and by causing a computer to read and execute the program recorded in this recording medium. The computer-readable recording medium means: a recording medium such as a flexible disk, a magneto-optical disk or a CD-ROM; or a recording device, such as a hard disk, which is included in the computer system.

While this invention has been described in conjunction with the preferred embodiment described above, it will now be possible for those skilled in the art to put this invention into practice in various manners.

What is claimed is:

1. An apparatus comprising:
first and second memories;
an indication which indicates necessity of a memory dump;
a storage unit;
a first unit which boots said apparatus without using said second memory when said indication indicates said necessity of the memory dump;
a second unit which copies the content of said second memory into said storage unit; and
a third unit which copies the content of said first memory into said second memory, wherein the content of said first memory is formed when said first unit boots said apparatus.

2. The apparatus as claimed in claim 1, wherein said indication is a flag.

3. The apparatus as claimed in claim 1, further comprising:
a fourth unit which changes said indication not to indicate said necessity of the memory dump after said third unit finishes copying the content of said first memory into said second memory.

4. The apparatus as claimed in claim 1, wherein first and second memories are configured a mirrored memory.

5. An apparatus comprising:
first and second memories;
a first indication which indicates said first and second memories does not store the same contents;
a storage unit;
a first unit which boots said apparatus without using said second memory and activates said first indication;
a second unit which copies the content of said second memory into said storage unit in accordance with said first indication; and
a third unit which copies the content of said first memory into said second memory in accordance with said first indication, wherein the content of said first memory is formed when said first unit boots said apparatus.

6. The apparatus as claimed in claim 5, wherein said first indication is a flag.

7. The apparatus as claimed in claim 5, further comprising:
a second indication which indicates said first and second memories stores the same contents; and
a fourth unit which activates said second indication after said third unit finishes copying the content of said first memory into said second memory.

8. The apparatus as claimed in claim 5, wherein said first indication indicates necessity of a memory dump.

9. The apparatus as claimed in claim 5, wherein first and second memories are configured a mirrored memory.

10. A method for dumping a memory in an apparatus which includes first and second memories, a storage unit and an indication which indicates necessity of a memory dump, said method comprising:
booting said apparatus without using said second memory when said indication indicates said necessity of the memory dump;
copying the content of said second memory into said storage unit; and
copying the content of said first memory into said second memory, wherein the content of said first memory is formed by said booting step.

11. The apparatus as claimed in claim 10, wherein said indication is a flag.

12. The apparatus as claimed in claim 10, further comprising:
changing said indication not to indicate said necessity of the memory dump after the content of said first memory is completely copied into said second memory during said copying step.

13. The apparatus as claimed in claim 10, wherein first and second memories are configured a mirrored memory.

14. A method for dumping a memory in an apparatus which includes first and second memories, a storage unit, and a first indication which indicates said first and second memories does not store the same contents, said method comprising:
booting said apparatus without using said second memory based on said second indication;
activating said first indication;
copying the content of said second memory into said storage unit in accordance with said first indication; and
copying the content of said first memory into said second memory in accordance with said first indication, wherein the content of said first memory is formed by said booting step.

15. The method as claimed in claim 14, wherein said first indication is a flag.

16. The method as claimed in claim 14, further comprising:
activating a first indication which indicates said first and second memories stores the same contents, after the content of said first memory is completely copied into said second memory during said copying step.

17. The method as claimed in claim 14, wherein said first indication indicates necessity of a memory dump.

18. The method as claimed in claim 14, wherein first and second memories are configured a mirrored memory.
